(19) United States
(12) Patent Application Publication
(10) Pub. No.: US 2024/0428419 A1
(43) Pub. Date: Dec. 26, 2024

(54) IMAGE PROCESSING APPARATUS, IMAGE PROCESSING METHOD, AND NONTRANSITORY COMPUTER-READABLE STORAGE MEDIUM

(71) Applicants: NEC Corporation, Minato-ku, Tokyo (JP); NEC Communication Systems, Ltd., Minato-ku, Tokyo (JP)

(72) Inventors: Yuji Tahara, Tokyo (JP); Naoki Saikusa, Tokyo (JP); Kenji Inamoto, Tokyo (JP); Kana Nishiyama, Tokyo (JP); Osamu Honda, Tokyo (JP)

(73) Assignees: NEC Corporation, Minato-ku, Tokyo (JP); NEC Communication Systems, Ltd., Minato-ku, Tokyo (JP)

(21) Appl. No.: 18/687,905

(22) PCT Filed: Sep. 13, 2021
(86) PCT No.: PCT/JP2021/033558

§ 371 Date: Feb. 29, 2024

(51) Int. Cl. G06T 7/11; G06T 7/00

(52) U.S. Cl. CPC G06T 7/11; G06T 7/97

(57) ABSTRACT

An image processing apparatus (100) includes: an acquisition unit (102) that acquires a plurality of images acquired by photographing a same location at different timing; a selection unit (104) that compares at least two of the plurality of images, and selects a target region being a region where a difference between the two images satisfies a criterion; and a processing unit (106) that performs average processing of averaging the target region included in each of the at least two images.

### TECHNICAL FIELD

The present invention relates to a surveillance image generation system, an image processing apparatus, an image processing method, and a program.

### BACKGROUND ART

There are various techniques for removing capturing of a person (and an object) other than a surveillance target from a captured image of a surveillance camera, and the like. In particular, when a captured image of a surveillance camera is stored for a certain period of time, and the like, there are many cases where it is desirable to erase a person from the image also in view of personal privacy.

For example, Patent Document 1 describes that, in an image processing apparatus for a surveillance system, in order to accurately capture appearance of a surveillance target object, an image of a moving object such as a passer-by, or a short-term staying object is removed from a plurality of still images acquired by photographing a surveillance range in a time-series manner, and presence or absence of a change in a long-term staying object being present within the surveillance range is determined.

Patent Document 2 describes, in an apparatus for detecting a difference between images, a configuration for improving determination accuracy of presence or absence of a difference between a target image and a reference image.

### RELATED DOCUMENTS

### Patent Documents

Patent Document 1: Japanese Patent Application Publication No. 2010-278963
Patent Document 2: Japanese Patent Application Publication No. 2018-78454

### SUMMARY OF INVENTION

### Technical Problem

In general, when a plurality of time-series images are subjected to average processing, and processing of blurring a portion where there is a movement is performed, it is often a case where a shadow of a person faintly remains in the image after average processing.

The present invention has been made in view of the above circumstances, and an object of the present invention is to provide an image processing technique for making a person captured in an image less likely to remain.

### Solution to Problem

In each aspect of the present invention, each of the following configurations is adopted to solve the above-described problem.

A first aspect is related to an image processing apparatus.

The image processing apparatus according to the first aspect includes:
an acquisition unit that acquires a plurality of images acquired by photographing a same location at different timing;
a selection unit that compares at least two of the plurality of images, and selects a target region being a region where a difference between the two images satisfies a criterion; and
a processing unit that performs average processing of averaging the target region included in each of the at least two images.

A second aspect is related to an image processing method to be executed by at least one computer.

The image processing method according to the second aspect includes,
by an image processing apparatus:
acquiring a plurality of images acquired by photographing a same location at different timing;
comparing at least two of the plurality of images, and selecting a target region being a region where a difference between the two images satisfies a criterion; and
performing average processing of averaging the target region included in each of the at least two images.

Note that, as another aspect of the present invention, a program causing at least one computer to execute the above-described method of the second aspect, or a computer readable storage medium storing a program as described above may also be available. The storage medium includes a non-transitory tangible medium.

The computer program includes, when being executed by a computer, a computer program code causing the computer to implement the image processing method on an image processing apparatus.

Note that, any combination of the above-described constituent elements, and a configuration acquired by converting expression of the present invention among a method, an apparatus, a system, a storage medium, a computer program, and the like are also available as an aspect of the present invention.

Further, various constituent elements of the present invention are not required to be necessarily individually independent elements, and a configuration in which a plurality of constituent elements are formed as one member, a configuration in which one constituent element is formed of a plurality of members, a configuration in which a certain constituent element is a part of another constituent element, a configuration in which a part of a certain constituent element and a part of another constituent element overlap with each other, and the like may be available.

Further, a plurality of procedures are described in order in a method and a computer program of the present invention, but the order of the description does not limit an order in which a plurality of procedures are performed. Therefore, when a method and a computer program of the present invention are implemented, the order of the plurality of procedures can be changed within a range that a content is not impaired.

Furthermore, a plurality of procedures in a method and a computer program of the present invention are not limited to a configuration in which the procedures are performed at individually different timing. Therefore, a configuration in which another procedure occurs during execution of a certain procedure, a configuration in which execution timing of a certain procedure and execution timing of another procedure overlap partially or entirely, and the like may be available.

### Advantageous Effects of Invention

According to each of the above-described aspects, it is possible to provide an image processing technique for making a person captured in an image less likely to remain.

### BRIEF DESCRIPTION OF THE DRAWINGS

FIG. 1 It is a diagram conceptually illustrating a system configuration of a surveillance image generation system according to an example embodiment of the present invention.

FIG. 2 It is a block diagram illustrating a hardware configuration of a computer that achieves an image processing apparatus of the surveillance image generation system illustrated in FIG. 1.

FIG. 3 It is a functional block diagram logically illustrating a configuration of the image processing apparatus according to the example embodiment.

FIG. 4 It is a diagram illustrating average processing of an image.

FIG. 5 It is a diagram illustrating average processing of an image.

FIG. 6 It is a flowchart illustrating one example of an operation of the image processing apparatus.

FIG. 7 It is a diagram illustrating processing of removing a region of a person from a surveillance image.

FIG. 8 It is a flowchart illustrating one example of an operation of the image processing apparatus according to the example embodiment.

FIG. 9 It is a diagram illustrating average processing of an image.

FIG. 10 It is a diagram illustrating weighted average processing.

FIG. 11 It is a diagram illustrating one example of data structure of result information, and an update status.

### EXAMPLE EMBODIMENT

Hereinafter, example embodiments according to the present invention are described by using the drawings. Note that, in all drawings, a similar constituent element is indicated by a similar reference sign, and description thereof is not included as necessary. Further, in each drawing, a configuration of a portion not being relevant to the essence of the present invention is not included, and is not illustrated.

In the example embodiments, “acquisition” includes at least one of fetching data or information stored in another apparatus or a storage medium by an own apparatus (active acquisition), and inputting data or information being output from another apparatus to an own apparatus (passive acquisition). Examples of active acquisition include requesting or inquiring another apparatus and receiving a reply thereof, accessing to another apparatus or a storage medium and reading, and the like. Further, examples of passive acquisition include receiving information being distributed (or transmitted, push notified, or the like), and the like. Furthermore, “acquisition” may include selecting and acquiring from received data or information, or selecting and receiving distributed data or information.

### First Example Embodiment

### System Configuration

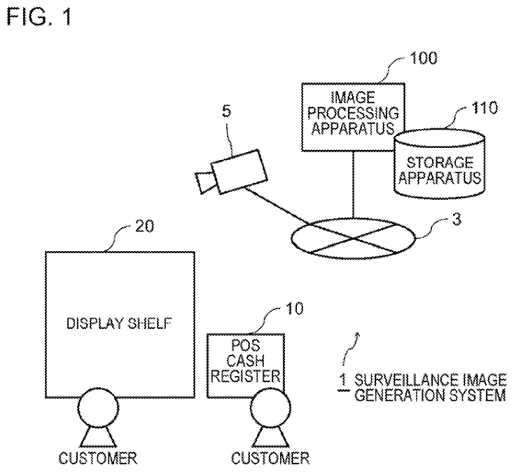

FIG. 1 is a diagram conceptually illustrating a system configuration of a surveillance image generation system 1 according to an example embodiment of the present invention.

An object of the surveillance image generation system 1 is to generate an image in which a person such as a customer is not captured into a surveillance image in a store or the like. The surveillance image generation system 1 includes a camera 5 that photographs a location serving as a surveillance target, and an image processing apparatus 100. The image processing apparatus 100 includes a storage apparatus 110. The storage apparatus 110 is, for example, a hard disk, a solid state drive (SSD), a memory card, or the like. The storage apparatus 110 may be an apparatus included inside the image processing apparatus 100, may be an apparatus independent of the image processing apparatus 100, or may be a combination thereof. The storage apparatus 110 may be, for example, a so-called online storage.

The storage apparatus 110 stores a captured image of the camera 5, a surveillance image to be generated by the image processing apparatus 100, and various pieces of information to be generated in a generation process of the surveillance image.

In the example in FIG. 1, the surveillance image generation system 1 generates a surveillance image acquired by photographing inside a store such as a convenience store. For example, the camera 5 photographs an area such as a cash register counter area where a POS cash register 10 is installed, and a product display area where a display shelf 20 and the like displaying a product is installed.

Since a generated surveillance image is used, for example, for performing surveillance of an increase or a decrease of a product within the display shelf 20, the image is preferably an image in which a person such as a customer or a salesperson is not captured. However, a purpose of use of a generated surveillance image is not limited thereto. For example, a display state of a product within the display shelf 20 may be determined, or freshness of food and ingredients may be surveyed, by using a surveillance image.

The POS cash register 10 is an apparatus with which at least one of a customer and a salesperson performs at least one of product registration processing and settlement processing. The display shelf 20 is a piece of furniture including at least one shelf plate or one plane on which a product is placed, a piece of furniture of a type on which a product is suspended and displayed, a refrigerated or frozen showcase, a gondola, and the like, but is not particularly limited. FIG. 1 illustrates only one POS cash register 10 and only one display shelf 20, but each of the POS cash register 10 and the display shelf 20 may be plural.

The camera 5 includes a lens, and an image capturing element such as a charge coupled device (CCD) image sensor. The camera 5 may be a network camera that communicates with the image processing apparatus 100 via a communication network 3, or may be a camera not being connected to the communication network 3.

FIG. 1 illustrates only one camera 5, but a plurality of the cameras 5 may be provided. An image to be generated by the camera 5 is at least one of a moving image, a still image, and a frame image at every predetermined interval.

An image generated by the camera 5 may be directly transmitted to the image processing apparatus 100, or may not be directly transmitted from the camera 5. An image generated by the camera 5 may be temporarily stored in a storage apparatus (may be the storage apparatus 110, or may be another storage apparatus (including a storage medium)), and the image processing apparatus 100 may read the image from the storage apparatus sequentially or at every predetermined interval. Further, an image to be transmitted to the image processing apparatus 100 may be a moving image, may be a frame image at every predetermined interval, or may be a still image sampled at a predetermined interval.

### Hardware Configuration Example

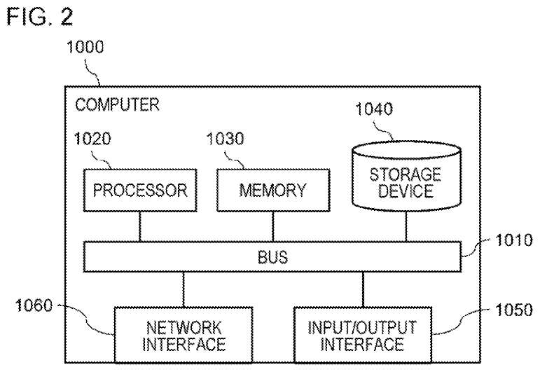

FIG. 2 is a block diagram illustrating a hardware configuration of a computer 1000 that achieves the image processing apparatus 100 of the surveillance image generation system 1 illustrated in FIG. 1.

The computer 1000 includes a bus 1010, a processor 1020, a memory 1030, a storage device 1040, an input/output interface 1050, and a network interface 1060.

The bus 1010 is a data transmission path along which the processor 1020, the memory 1030, the storage device 1040, the input/output interface 1050, and the network interface 1060 mutually transmit and receive data. However, a method of mutually connecting the processor 1020 and the like is not limited to bus connection.

The processor 1020 is a processor to be achieved by a central processing unit (CPU), a graphics processing unit (GPU), or the like.

The memory 1030 is a main storage apparatus to be achieved by a random access memory (RAM) or the like.

The storage device 1040 is an auxiliary storage apparatus to be achieved by a hard disk drive (HDD), a solid state drive (SSD), a memory card, a read only memory (ROM), or the like. The storage device 1040 stores a program module that achieves each function (e.g., an acquisition unit 102, a selection unit 104, a processing unit 106, and the like to be described later) of the image processing apparatus 100 of the surveillance image generation system 1. Each function associated with each program module is achieved by causing the processor 1020 to read each program module in the memory 1030 and execute the program module. Further, the storage device 1040 also functions as a storage unit (not illustrated) that stores various pieces of information to be used by the image processing apparatus 100. Further, the storage apparatus 110 may be achieved by the storage device 1040.

A program module may be stored in a storage medium. A storage medium storing a program module may include a non-transitory tangible medium usable by the computer 1000, and a program code readable by the computer 1000 (processor 1020) may be embedded in the medium.

The input/output interface 1050 is an interface for connecting the computer 1000 to various input/output devices.

The network interface 1060 is an interface for connecting the computer 1000 to the communication network 3. The communication network 3 is, for example, a local area network (LAN) or a wide area network (WAN). A method of connecting the network interface 1060 to the communication network 3 may be wireless connection, or may be wired connection. However, the network interface 1060 may not be used.

Then, the computer 1000 is connected to a necessary device (e.g., the camera 5, a display (not illustrated), an operation unit (not illustrated), and the like) via the input/output interface 1050 or the network interface 1060.

The surveillance image generation system 1 may be achieved by a plurality of computers 1000 constituting the image processing apparatus 100.

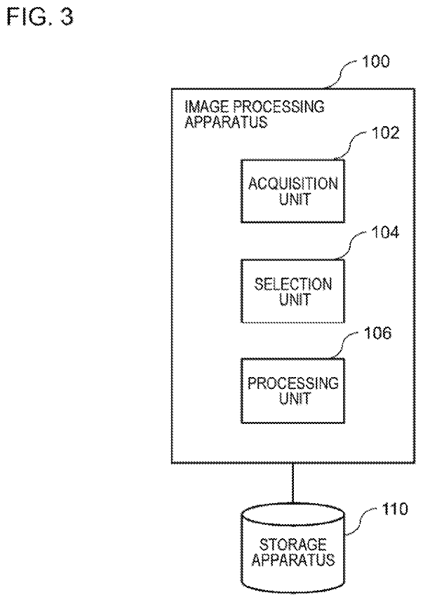

Each constituent element of the image processing apparatus 100 according to the present example embodiment in FIG. 3 to be described later is achieved by any combination of hardware and software of the computer 1000 in FIG. 2. Further, it should be understood by a person skilled in the art that there are various modification examples as a method and an apparatus for achieving the image processing apparatus 100. A functional block diagram illustrating the image processing apparatus 100 according to each example embodiment does not illustrate a configuration on the basis of hardware, but illustrates a block on the basis of a logical function.

### Functional Configuration Example

FIG. 3 is a functional block diagram logically illustrating a configuration of the image processing apparatus 100 according to the present example embodiment.

The image processing apparatus 100 includes the acquisition unit 102, the selection unit 104, and the processing unit 106.

The acquisition unit 102 acquires a plurality of images acquired by photographing a same location at different timing. The selection unit 104 compares at least two of the plurality of images, and selects a target region being a region where a difference between the two images satisfies a criterion. The processing unit 106 performs average processing of averaging the target region included in each of the at least two images.

A location serving as a photographing target is a product display area, a surrounding area of a cash register, and the like. For example, it is possible to detect a product out of stock, and detect disorder of a display state of a product, by using a captured image, and instruct a salesperson to replenish a product or organize a product on the display shelf 20.

Photographing timing is a predetermined sampling interval, for example, is a one-minute interval, a five-minutes interval, a ten-minutes interval, and the like, and may be set according to a photographing target. This is because a staying time of a customer differs depending on a type of a store, a location condition, an area within a store, a type of a displayed product, and the like. A duration of time when a customer stops in front of a product differs, for example, depending on a type of a store such as a convenience store, a department store, and a bookstore, and generally, a staying time of a customer in a convenience store is shorter than that in a department store, and a staying time of a customer in a bookstore is longer than that in a department store. Also, a staying time of a customer differs also depending on whether a location condition of a store is in front of a station, along a main road, a downtown area, a resort area, a residential area, or the like, and for example, in a store in front of a station or the like, it is highly likely that a staying time of a customer is short as compared with another store.

Further, within a store, a staying time of a customer differs between an area where a product is displayed, and an area in front of a cash register, and a staying time also differs depending on a type of a displayed product (sales area). For example, in a convenience store, it is highly likely that a staying time of a customer is long in an area of a magazine, as compared with another product (e.g., groceries). Further, whether a cash register is busy also differs depending on a store or an area within a store, and even in the same store or area, furthermore, a case where whether a cash register is busy differs depending on a time period is also conceived.

Further, also within one image, since there is a location (region) where a person is likely to stay, and a location (region) where a person is unlikely to stay, a sampling interval may be settable according to a region within an image. This configuration is described in detail in an example embodiment to be described later.

A simplex of a region to be compared by the selection unit 104 is, for example, 1 pixel.

However, it is not limited to a pixel. For example, comparison may be made for a region including a surrounding pixel. It is possible to prevent occurrence of small noise, as compared with processing on the basis of a simplex pixel.

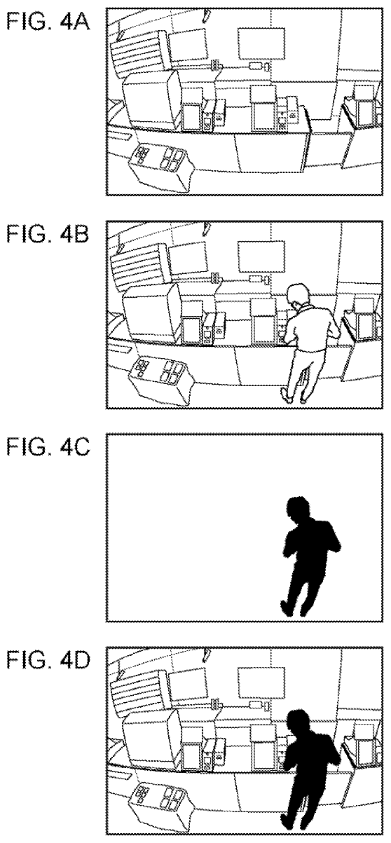

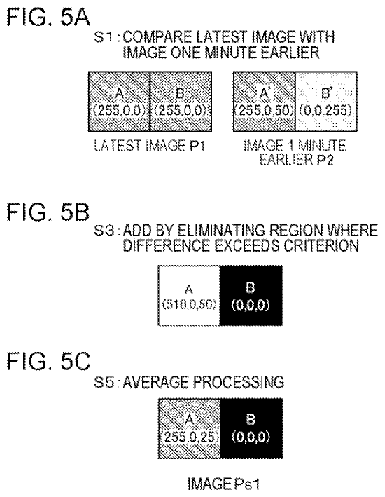

FIGS. 4 and 5 are diagrams illustrating average processing of an image. FIG. 4(a) illustrates one example of a surveillance image of the POS cash register 10 within a store. In FIG. 4(b), a customer moves to a front of the POS cash register 10, and operates the POS cash register 10. In FIG. 4(c), an image in FIG. 4(a) and an image in FIG. 4(b) are compared, and a region (non-target region) where a difference between the images does not satisfy a criterion is indicated in black. FIG. 4(d) illustrates a result of combining the image in FIG. 4(a) and the image in FIG. 4(b), and illustrates that the region (non-target region) where the difference between the two images does not satisfy a criterion is not subjected to average processing, and remains in black.

A manner in which the above-described image processing is performed on the basis of a pixel unit is described by using FIG. 5.

FIG. 5(a) illustrates a latest image P1 constituted of two pixels A and B adjacent to each other, and an image P2 one minute earlier than the image P1. The pixel A of the image P1 and a pixel A′ of the image P2 have the same region, and the pixel B of the image P1 and a pixel B′ of the image P2 have the same region. The selection unit 104 compares the pixel A of the image P1 with the pixel A′ of the image P2, and also compares the pixel B of the image P1 with the pixel B′ of the image P2 (step S1).

In the present example embodiment, each pixel is indicated by an RGB value. For example, the selection unit 104 compares for each value, and discriminates whether a difference of at least one of the values satisfies a criterion. For example, a region where a difference of at least one of the values is equal to or less than a criterion may be selected as a target region. The criterion is set, for example, in such a way that the difference is equal to or less than 100. The criterion is one example, and the example embodiment is not limited thereto. The criterion may be set according to a surveillance target. The criterion may be, for example, a value capable of detecting a difference between a color of a product, and a color of a background of the product with predetermined accuracy or more. Alternatively, a configuration in which a distribution range (or a distance) of two RGB values is within a predetermined range (predetermined distance) may be set as the criterion.

FIG. 5(b) illustrates a diagram in which each region of the image P1 and each region of the image P2 are combined. In this example, since a difference between the pixel A of the image P1 and the pixel A′ of the image P2 is equal to or less than 100, the criterion is satisfied, and therefore, the pixel A of the image P1 and the pixel A′ of the image P2 are selected, and added as a target region. Specifically, each value of RGB values of the pixel A of the image P1 and the pixel A′ of the image P2 is added. Meanwhile, since a difference between the pixel B of the image P1 and the pixel B′ of the image P2 is such that a R value and a B value exceed 100, the region of the pixel B is not selected (non-target region), and is removed from a combined image (step S3). To eliminate the region of the pixel B from addition, in the example in FIG. 5(b), 0 is set to each value of RGB values of the pixel B (in FIG. 5(b), indicated as (0, 0, 0)), followed by addition.

FIG. 5(c) illustrates each region (the pixel A and the pixel B) of an image Ps1 after average processing. An average value of each value is derived by subtracting each value of RGB values added in step S3 by the number of added images (herein, 2 being two images P1 and P2) (step S5). The region (target region) of the pixel A of the image Ps1 after the average processing is subjected to average processing, but the region (non-target region) of the pixel B is eliminated from the average processing.

Further, in the example embodiment, the average processing is performed by using two images, but the example embodiment is not limited thereto. The average processing may be performed by using two or more images.

### Operation Example

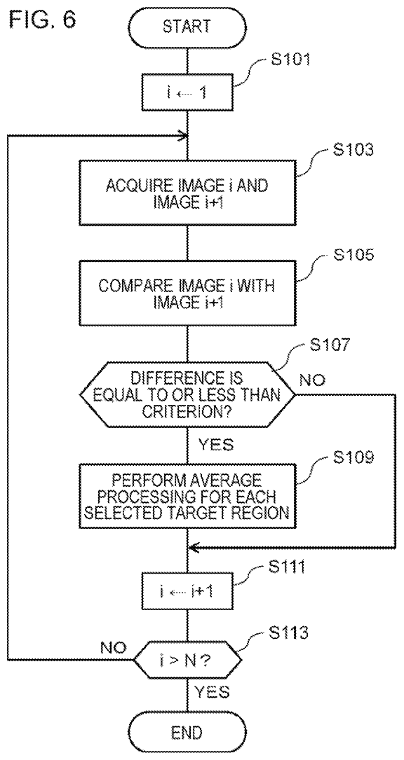

An operation of the image processing apparatus 100 configured as above is described. FIG. 6 is a flowchart illustrating one example of an operation of the image processing apparatus 100.

First, the image processing apparatus 100 sets 1 in a counter i (step S101). Then, the acquisition unit 102 acquires a latest image P1 (Pi) and an image P2 (Pi+1) one minute earlier than the image P1 (step S103).

The selection unit 104 compares the two images P1 and P2 (step S105). Herein, each piece of processing from step S107 to step S109 is performed for each of a plurality of regions within an image. The selection unit 104 determines, for each region, whether a difference satisfies a criterion, herein, whether the difference is equal to or less than the criterion (step S107). The selection unit 104 selects, as a target region, a region where the difference satisfies the criterion, herein, a region where the difference is equal to or less than the criterion (YES in step S107), and the processing unit 106 adds the region of the image P1 and the region of the image P2 being the selected target region, and performs average processing (step S109). Among a plurality of regions of the images P1 and P2, a region where the difference does not satisfy the criterion, herein, a region where the difference exceeds the criterion (NO in step S107) becomes a non-target region, is not selected, and step S109 is bypassed, then the processing proceeds to step S111.

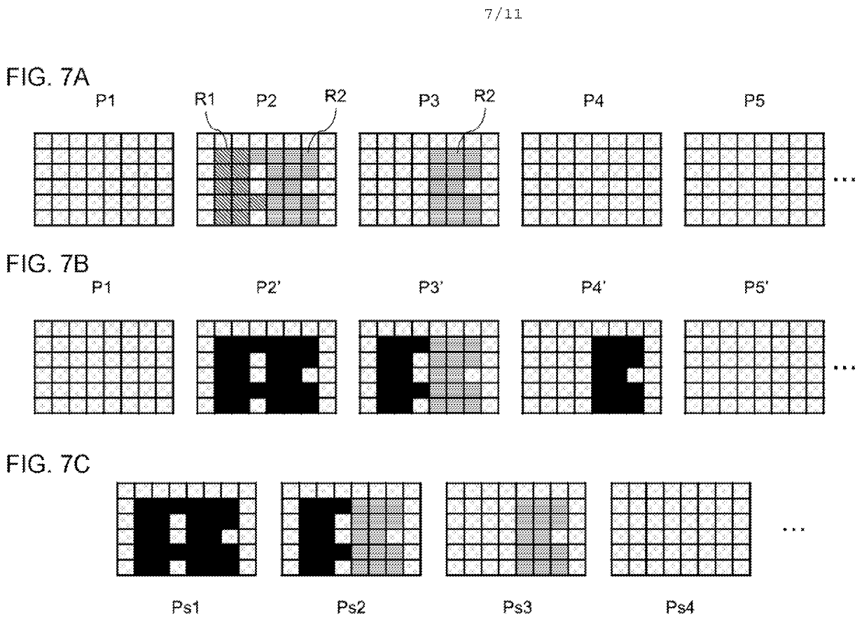

FIG. 7 is a diagram illustrating processing of removing a region of a person from a surveillance image. For example, as illustrated in FIG. 7(a), among a plurality of surveillance images P1 to Pn (where n is a natural number), moving object regions R1 and R2 are present in a middle portion between an image P2 and an image P3. The moving object regions R1 and R2 are, for example, a customer moving within a store.

FIG. 7(b) illustrates each of images after exclusion processing of a region where a difference does not satisfy a criterion is performed as a result of comparison of two images. FIG. 7(c) illustrates each of combined images after average processing.

As illustrated in FIG. 7(b), as a result of comparison of the image P1 with the image P2, a region (non-target region) not being selected in an image P2′ acquired by eliminating the moving object regions R1 and R2, as a region where the difference does not satisfy the criterion, is illustrated in black. In a combined image Ps1 acquired by adding, as a target region, the selected regions of the images P1 and P2′, and performing the average processing, a black region where the average processing is not performed remains.

Referring back to FIG. 6, in step S111, the counter i is incremented, and it is determined whether the counter i exceeds a predetermined number N (step S113). Herein, the predetermined number N is the number of times the average processing of an image is performed, and, for example, is set in advance to 10. However, the number N of times the average processing is performed is not limited thereto. When the counter i exceeds N (YES in step S113), the present processing is finished. When the counter i does not exceed N (NO in step S113), the processing returns to step S103, and the acquisition unit 102 acquires the image P2 one minute earlier, and the image P3 two minutes earlier.

Then, the selection unit 104 compares the image P2 with the image P3 (step S105). Herein, each piece of processing from step S107 to step S109 is performed for each of a plurality of regions within an image. The selection unit 104 determines, for each region, whether the difference satisfies the criterion, herein, whether the difference is equal to or less than the criterion (step S107). The selection unit 104 selects, as a target region, a region where the difference satisfies the criterion, herein, a region where the difference is equal to or less than the criterion (YES in step S107), and the processing unit 106 adds the region of the image P2 and the region of the image P3 being the selected target region, and performs the average processing (step S109).

Consequently, as illustrated in FIG. 7(b), as a result of comparison of the image P2 with the image P3, a non-target region not being selected in an image P3′ acquired by eliminating a region where the difference does not satisfy the criterion is illustrated in black. Then, as illustrated in FIG. 7(c), in a combined image Ps2 acquired by adding a selected target region of the images P2 and P3′, and performing the average processing, a black region where the average processing is not performed remains. Meanwhile, the target region where the difference satisfies the criterion is subjected to the average processing.

Referring back to FIG. 6, the counter i is further incremented (step S111), the processing returns to step S103, and when the processing is repeated, as illustrated in FIG. 7(c), combined images Ps3 and Ps4 are acquired. In this way, in the images P1 to P5, the moving object regions R1 and R2 being present between the images P2 and P3 are no longer present in the image Ps4 generated by the average processing. In other words, an image in which a customer being a moving object captured in the image is erased is generated.

As described above, in the present example embodiment, a plurality of images acquired by photographing a same location at different timing by the acquisition unit 102 are compared by the selection unit 104, a region where a difference between the images satisfies a criterion is selected as a target region, and average processing of averaging the target region included in each of the two images is performed by the processing unit 106. Thus, according to the present example embodiment, since a portion where the difference is large within an image can be eliminated from a target for the average processing, it is possible to remove, from the image, a customer or the like being temporarily captured. Further, since a portion where the difference is large is not included in an image to be acquired as a result of the average processing, it is possible to prevent entering of noise (an object or a person being temporarily present) into an image to be generated.

### Second Example Embodiment

The present example embodiment is the same as the above-described example embodiment except for a point that the present example embodiment provides an end criterion of average processing. Since an image processing apparatus 100 according to the present example embodiment includes the same configuration as the above-described example embodiment, the image processing apparatus 100 is described by using FIG. 3. Note that, the present example embodiment can also be combined with another example embodiment to be described later.

In the image processing apparatus 100, a selection unit 104 compares at least two images by changing a combination of images to be compared until average processing is performed for a region of a reference range or more within an image, and a processing unit 106 repeats the average processing.

The reference range may be a predetermined ratio (e.g., 90% or the like) with respect to a region of the entirety of an image, or a predetermined ratio (e.g., 90% or the like) with respect to a predetermined region within an image, for example, a region in front of a POS cash register 10 or a display shelf 20, or a specific region (e.g., a region of a specific product) within the predetermined region. Further, a different criterion may be provided for each predetermined region within an image. For example, a region of a display shelf or a product may be set to 99%, a region of an aisle or a background may be set to 80%, or the like.

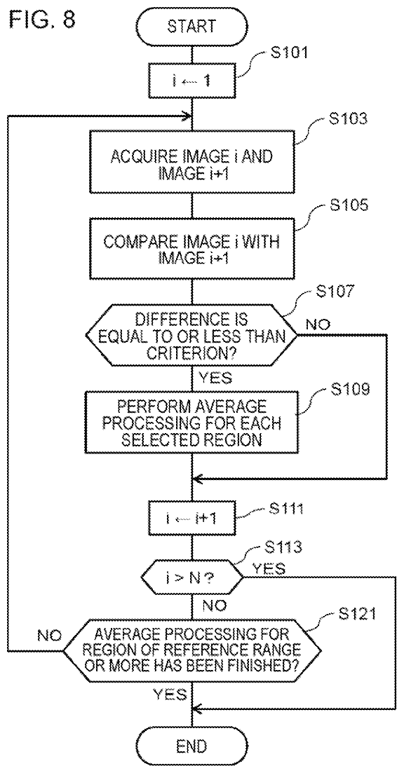

FIG. 8 is a flowchart illustrating one example of an operation of the image processing apparatus 100 according to the present example embodiment. A processing procedure according to the present example embodiment further includes step S121, in addition to steps S101 to S113 in the flowchart in FIG. 6 of the above-described example embodiment.

In FIG. 6, when a counter i does not exceed a predetermined number N (NO in step S113), the image processing apparatus 100 determines whether average processing is finished for a region of a reference range or more (step S121). The determination processing may be performed by at least one of an acquisition unit 102, the selection unit 104, and the processing unit 106, and any of the acquisition unit 102, the selection unit 104, and the processing unit 106 may be performed.

When the average processing is not finished for the region of the reference range or more (NO in step S121), the processing returns to step S103, and repeats the processing. When the average processing is finished for the region of the reference range or more (YES in step S121), the processing is finished.

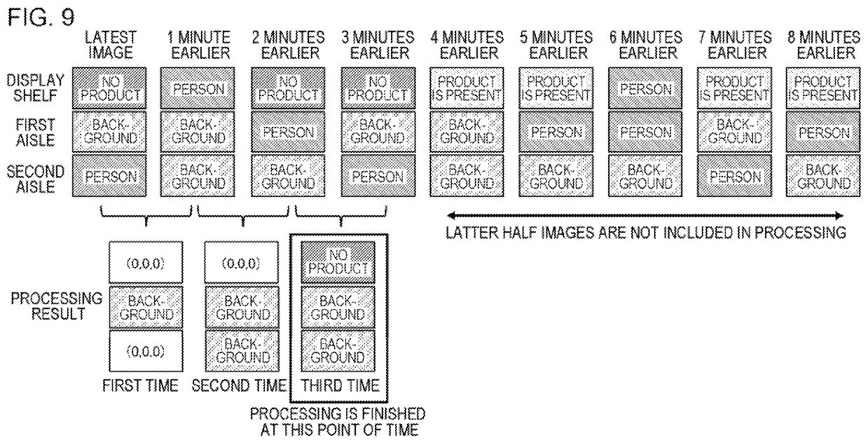

A specific example is described by using FIG. 9. A case where processing is performed by dividing an image into a region of a display shelf 20, and a region of two aisles (first and second aisles) is described. In this way, by performing image analysis processing for an image by the image processing apparatus 100, processing may be performed for each region by discriminating a region within the image among a person, a background, a display shelf, and a product. The image analysis processing may be performed by a not-illustrated image analysis processing apparatus, and the image analysis processing apparatus may be included in the image processing apparatus 100, may be an apparatus other than the image processing apparatus 100, or may be a combination of these apparatuses.

FIG. 9 illustrates a scene of each region from a latest image until an image eight minutes earlier than the latest image. A product is present in the display shelf 20 until the image four minutes earlier, but the product runs out three minutes earlier and thereafter. Further, a person is sometimes captured in a region of the display shelf 20 or each aisle within the image. When a person is not present in the region of the display shelf 20 or each aisle within the image, a background or the display shelf 20 is captured.

First, in the latest image, a product is not captured in the region of the display shelf 20, and a person is captured in the second aisle. In the image one minute earlier, a person is captured in the region of the display shelf 20, and a person is not captured in the first and second aisles. Therefore, in a comparison result of the latest image with the image one minute earlier, the region of the display shelf 20 and the region of the second aisle are eliminated, and the region of the first aisle is subjected to average processing as a target region.

Then, in the image two minutes earlier, a product is not captured in the region of the display shelf 20, and a person is captured in the first aisle. Therefore, in a comparison result of the image one minute earlier with the image two minutes earlier, the region of the display shelf 20 and the region of the first aisle are eliminated, and the region of the second aisle is subjected to the average processing as a target region.

Then, in the image three minutes earlier, a product is not captured in the region of the display shelf 20, and a person is captured in the second aisle. Therefore, in a comparison result of the image two minutes earlier with the image three minutes earlier, the regions of the first and second aisles are eliminated, and the region of the display shelf 20 is subjected to the average processing as a target region.

Thus, since the average processing is finished for all the three regions within the image, the image processing apparatus 100 finishes the average processing. Processing of an image four minutes earlier and thereafter can be not included. Thus, in this example, since there is no likelihood that an image four minutes earlier in which a product is present on the display shelf 20 is not added for the average processing, it becomes possible to generate an image indicating a latest state in which a product is not present on the display shelf 20, and also possible to reduce a processing load.

Further, when processing for a region of a reference range or more is not finished even when the average processing is performed a predetermined number of times (e.g., ten times), it is assumed that image generation at the time has failed, and processing may be performed by acquiring an image at another time again. Further, the image processing apparatus 100 may further include a unit (not illustrated) that stores or outputs (notifies) that image generation has failed.

According to the present example embodiment, since an advantageous effect similar to that of the above-described example embodiment is achieved, and also processing is finished after average processing is performed for a region of a reference range or more, even when the average processing is not performed for the entire region of an image, the average processing can be finished as long as processing is finished for a necessary region, and a processing load can be reduced. Further, when an image is used for confirmation of a display state, it is desirable that an afterimage of a product does not remain, and the present example embodiment is also advantageous in this point.

### Third Example Embodiment

The present example embodiment is the same as the above-described first and second example embodiments except for a point that the present example embodiment includes a configuration in which a weight is applied to an image in average processing. Since an image processing apparatus 100 according to the present example embodiment includes the same configuration as that of the example embodiment in FIG. 3, the image processing apparatus 100 is described by using FIG. 3. In the present example embodiment, although a configuration in which the present example embodiment is combined with the second example embodiment is described as an example, the present example embodiment may be combined with another example embodiment.

When performing average processing, a processing unit 106 applies a weight to each image by using a difference from a latest image on a time axis.

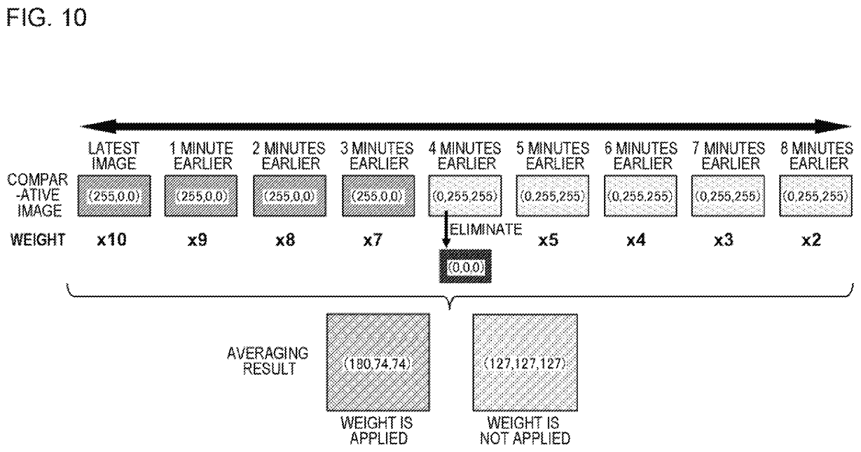

FIG. 10 is a diagram illustrating the average processing when weighting according to the present example embodiment is performed. In the example, the average processing is performed by using an image every one minute. In the example, a weighting factor is set for images from a latest image up to an image nine minutes earlier in such a way that the weighting factor decreases as exemplified by 10, 9, 8, . . . , 2, and 1 each time when the image goes back to the past.

In other words, performing image processing (with a weight) while relying on more up-to-date information (image) enables to more accurately reflect a current status to an image. For example, performing the average processing by applying a weight to a new image in which a product runs out enables to generate an image accurately indicating a current status in which the product runs out, rather than adding a past image in which the product is present to the average processing in an image of a display shelf 20 after the product is picked up by a customer for purchasing.

As illustrated in FIG. 10, it is clear that a result acquired by performing weighting is closer to a latest image than a result in which weighting is not performed.

Further, a selection unit 104 repeatedly selects two images adjacent to each other in a time-series manner, and the processing unit 106 performs the average processing each time the selection unit 104 selects two images. Herein, the average processing by the processing unit 106 is expressed by an equation (1).

$$\begin{matrix}[ Mathematical 1 ] & \\ X = \frac{{\sum }_{i = 1}^{N} ( {k}_{i} \times {c}_{i} )}{{\sum }_{i = 1}^{N} {k}_{i}} & equation ( 1 )\end{matrix}$$

In the present example embodiment, the average processing is performed by using the equation (1) each time two images are selected. Therefore, the processing unit 106 stores, in a storage apparatus 110, a computation result up to a previous time, as result information 120, and updates the result information 120 stored in the storage apparatus 110 each time the average processing is performed.

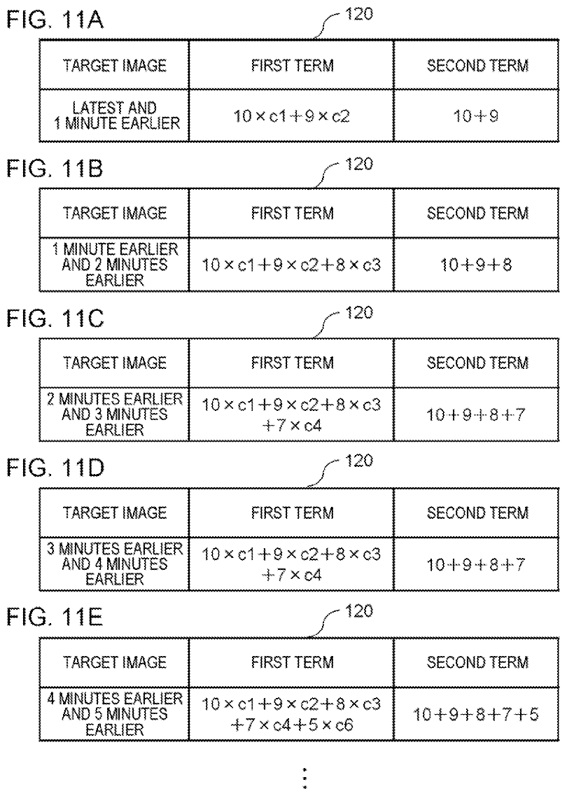

As illustrated in FIG. 11, a result (result information 120) of the average processing includes, for each target region, information indicating each of a first term (numerator of the equation (1)) indicating a result acquired by summing a value acquired by multiplying a value ci of the target region by a weighting factor ki, and a second term (denominator of the equation (1)) indicating a summation result of the weighting factor ki used in the multiplication. Herein, i is a natural number, and a latest image in a time-series manner is i=1. ki is a weighting factor, and the value of ki increases, as the factor ki is used in a latest image in a time-series manner. N is a sampling number of images for the average processing. When the average processing is finished for a region of a reference range or more before i reaches the sampling number N, the average processing is finished even when i is smaller than the sampling number N.

When the average processing is performed for the subsequent two images, the processing unit 106 adds, to a result (result information 120) of the average processing stored in the storage apparatus 110, the first term and the second term of a target region of an image at this time.

For example, when the average processing is performed for images from a latest image to an image five minutes earlier, as illustrated in FIG. 11, each term is updated by being added to the result information 120 each time computation is performed.

A comparison result of the latest image with an image one minute earlier becomes

X1=(10×c1+9×c2)/(10+9) (FIG. 11(a))

A comparison result of the image one minute earlier with an image two minutes earlier is added to X1, thereby yielding

X2=(10×c1+9×c2+8×c3)/(10+9+8) (FIG. 11(b))

A comparison result of the image two minutes earlier with an image three minutes earlier is added to X2, thereby yielding

X3=(10×c1+9×c2+8×c3+7×c4)/(10+9+8+7) (FIG. 11(c))

In a comparison result of the image three minutes earlier with an image four minutes earlier, since a difference regarding a region of the image four minutes earlier exceeds a criterion, the region is eliminated, and therefore, an associated term is not added, and a value at the previous time is maintained.

X4=(10×c1+9×c2+8×c3+7×c4)/(10+9+8+7) (FIG. 11(d))

A comparison result of the image four minutes earlier with an image five minutes earlier is added to X4, thereby yielding

X5=(10×c1+9×c2+8×c3+7×c4+5×c6)/(10+9+8+7+5) (FIG. 11(e))

Herein, a value to be stored in the result information 120 is position information on a target region of each image Pi, and a summation result of each of the first term and the second term regarding a numerator and a denominator, however, the value may be a value of an individual term before summation of each of the first term and the second term. Alternatively, the result information 120 may be stored in such a way that position information on a region of each image Pi, the RGB value ci, the weighting factor ki, and information indicating whether the image is to be added are associated with one another.

According to the present example embodiment, an advantageous effect similar to that of the above-described example embodiments is achieved, and it is possible to accurately reflect a current status of a surveillance target to a generated image, since average processing is performed by applying a large weight to a more up-to-date image, or applying a small weight to an image in which a difference is large. However, the status may not be a “current” status, and when a past image is processed, the status becomes a status of an image at a point of time when processing has started.

### Fourth Example Embodiment

The present example embodiment is different from the above-described example embodiments in a point that the present example embodiment includes a configuration in which a sampling interval of an image to be processed is set. Since an image processing apparatus 100 according to the present example embodiment includes the same configuration as that of the example embodiment in FIG. 3, the image processing apparatus 100 is described by using FIG. 3. The present example embodiment is described by a configuration in which the present example embodiment is combined with the third example embodiment, as an example, but the present example embodiment can be combined with another example embodiment in a range that does not cause a contradiction.

A processing unit 106 performs average processing by setting a sampling interval of an image according to a region.

The sampling interval may be a predetermined value, or may be dynamically changed.

Further, the processing unit 106 computes a time until a change of a reference value or more occurs in a region, and sets the computed time to a sampling interval for each region, by processing an image in a past.

As described above, the sampling interval may be set for each region within an image. For example, since a frequency of capturing a moving object (a customer or a salesperson), a staying time, appearance timing, and the like differ depending on a location, a frequency or timing of replacement (a product runs out because of sales) of a surveillance target (e.g., a specific product) differs depending on a target, a time period, or the like, it is possible to improve accuracy of image processing by setting an appropriate sampling interval according to a condition for each target.

Further, a frequency of appearance of a moving object or a product sales status also changes depending on whether the day is a week day or a holiday, presence or absence of an event (a campaign or sales), working hours, or a time period such as a daytime and a nighttime. Therefore, the sampling interval may be set depending on whether the day is a week day or a holiday, presence or absence of an event (a campaign or sales), working hours, or for each time period such as a daytime and a nighttime.

As described above, the example embodiments according to the present invention have been described with reference to the drawings, but these example embodiments are an example of the present invention, and various configurations other than the above can also be adopted.

For example, in the above example embodiments, a weighting factor is set depending on a timewise factor, however, in another example, when a difference in change between images is large, for example, when the difference exceeds a predetermined criterion, the weighting factor may be set small (e.g., 0.1 or the like). The factor may be multiplied by a weighting factor according to a time-series order, or only the factor may be used without using a weighting factor according to a time-series order.

The above configuration enables to prevent a state of an image in which a change is large from affecting an average image.

In the above-described example embodiments, although processing is performed by using an RGB value, a hue and brightness of an image may be used. A selection unit 104 determines that a difference is equal to or less than a criterion, when a change in hue of an image is equal to or less than a criterion and a change in brightness is equal to or more than a criterion.

For example, a case in which an RGB value does not accurately indicate a difference is conceived, such as a case where a location in which sunlight from outdoors shines is included in an image region. Therefore, the selection unit 104 may perform determination processing by using a hue and brightness in place of an RGB value, depending on a condition. Further, the processing unit 106 may also perform average processing by using a hue and brightness in place of an RGB value. Alternatively, the processing unit 106 may perform both of processing (determination or average processing) using an RGB value, and processing (determination or average processing) using a hue and brightness. For example, the selection unit 104 may select a target region by eliminating a region where a difference does not satisfy a criterion by at least one of the determination results.

The condition may be, for example, a time period, a season, or the like when sunlight shines, or may be weather. For example, a configuration may be a configuration in which a hue and brightness are used in place of an RGB value in a condition such as in the afternoon of a sunny day.

According to this configuration, even when detection of a difference of an image by an RGB value is difficult depending on an illuminance condition of light, it is possible to describe accuracy of detection of a difference later by using a hue and brightness.

Note that, a value indicated by a color expressing method other than the RGB value, or a hue and brightness may be used. For example, a color space such as YUV, YCbCr, or YPbPr may be used. In these color spaces, since it is possible to express color information in terms of a bit number in which a data amount per pixel is reduced, it is possible to reduce the data amount of an image to be processed. Further, in a case where an image is used for confirmation of a display state of the product, when it is known that a contrast between a display location of a product, and the product is large, the selection unit 104 may not use a color difference signal (a U signal or a V signal in case of YUV), and may determine whether a criterion is satisfied by determining whether a difference in luminance (Y signal) is equal to or less than a criterion.

In addition, a difference may be discriminated, or average processing may be performed, by using other color expressing methods such as a cyan magenta yellow key plate (CMYK) color model, a commission Internationale de l'Eclairage (CIE) XYZ color space, a xyY color system, a L*u*v* color system, and a L*a*b* color system. Which one of the expressing methods is used may be selected as necessary according to a nature or the like of a color of a surveillance target within an image. Further, a color expressing method for use may be changed according to a target (a product, a background, or a person) within an image region.

Further, in the above-described example embodiment, average processing is performed by using two images adjacent to each other in a time-series manner, but the example embodiment is not limited thereto. For example, regarding a region where average processing is not completed before average processing of a latest image and an image one minute earlier, and average processing of the image one minute earlier and an image two minutes earlier are completed, comparison of the latest image with an image three minutes earlier may be performed, and average processing for the acquired target region may be performed.

According to this configuration, it becomes possible to generate an image closer to a latest state.

While the invention of the present application has been described with reference to the example embodiments and examples, the invention of the present application is not limited to the above-described example embodiments and examples. A configuration and details of the invention of the present application may be modified in various ways comprehensible to a person skilled in the art within the scope of the invention of the present application.

Note that, in a case where information related to a user is acquired and used in the present invention, the acquisition and the usage are assumed to be performed legally.

A part or all of the above-described example embodiments may also be described as the following supplementary notes, but is not limited to the following.

Hereinafter, an example of a reference embodiment is supplementarily described.
1. An image processing apparatus including:
   an acquisition unit that acquires a plurality of images acquired by photographing a same location at different timing;
   a selection unit that compares at least two of the plurality of images, and selects a target region being a region where a difference between the two images satisfies a criterion; and
a processing unit that performs average processing of averaging the target region included in each of the at least two images.
2. The image processing apparatus according to supplementary note 1, wherein,
   until the average processing is performed for a region of a reference range or more within the image,
   the selection unit compares the at least two images by changing a combination of the images to be compared, and
   the processing unit repeats the average processing.
3. The image processing apparatus according to supplementary note 1 or 2, wherein
   a unit of the region is one pixel.
4. The image processing apparatus according to any one of supplementary notes 1 to 3, wherein
   the processing unit applies a weight to the image by using a difference from the latest image on a time axis, when performing the average processing.
5. The image processing apparatus according to supplementary note 4, wherein
   the selection unit repeatedly selects two images adjacent to each other in a time-series manner,
   the processing unit performs the average processing each time the selection unit selects the two images,
   a result of the average processing includes, for the each target region, information indicating a first term indicating a value acquired by multiplying a value of the target region by a weighting factor, and a second term indicating the weighting factor used in the multiplication, and is stored in a storage unit, and,
   when performing the average processing for the subsequent two images, the processing unit adds, to the result of the average processing stored in the storage unit, the first term and the second term of the target region of the image at this time.
6. The image processing apparatus according to any one of supplementary notes 1 to 5, wherein
   the processing unit performs the average processing by setting a sampling interval of the image according to the region.
7. The image processing apparatus according to supplementary note 6, wherein
   the processing unit computes a time until a change of a reference value or more occurs in the region, and sets the computed time to the sampling interval for the each region, by processing an image in a past.
8. The image processing apparatus according to any one of supplementary notes 1 to 7, wherein
   a sampling interval of a plurality of the images differs depending on a photographing target.
9. The image processing apparatus according to any one of supplementary notes 1 to 8, wherein
   the selection unit determines that the difference is equal to or less than a criterion, when a change in hue of the image is equal to or less than a criterion and a change in brightness is equal to or more than a criterion.
10. A surveillance image generation system including:
   an image processing apparatus; and
   a surveillance camera that photographs a same location at different timing, and generates a plurality of images, wherein
   the image processing apparatus includes
   an acquisition unit that acquires the plurality of images generated by the surveillance camera,
   a selection unit that compares at least two of the plurality of images, and selects a target region being a region where a difference between the two images satisfies a criterion, and
   a processing unit that performs average processing of averaging the target region included in each of the at least two images.
11. The surveillance image generation system according to supplementary note 10, wherein,
   until the average processing is performed for a region of a reference range or more within the image,
   in the image processing apparatus,
      the selection unit compares the at least two images by changing a combination of the images to be compared, and
      the processing unit repeats the average processing.
12. The surveillance image generation system according to supplementary note 10 or 11, wherein
   a unit of the region is one pixel.
13. The surveillance image generation system according to any one of supplementary notes 10 to 12, wherein
   the processing unit of the image processing apparatus applies a weight to the image by using a difference from the latest image on a time axis, when performing the average processing.
14. The surveillance image generation system according to supplementary note 13, wherein,
   in the image processing apparatus,
      the selection unit repeatedly selects two images adjacent to each other in a time-series manner,
      the processing unit performs the average processing each time the selection unit selects the two images,
      a result of the average processing includes, for the each target region, information indicating a first term indicating a value acquired by multiplying a value of the target region by a weighting factor, and a second term indicating the weighting factor used in the multiplication, and is stored in a storage unit, and,
      when performing the average processing for the subsequent two images, the processing unit adds, to the result of the average processing stored in the storage unit, the first term and the second term of the target region of the image at this time.
15. The surveillance image generation system according to any one of supplementary notes 10 to 14, wherein,
   in the image processing apparatus,
      the processing unit performs the average processing by setting a sampling interval of the image according to the region.
16. The surveillance image generation system according to supplementary note 15, wherein,
   in the image processing apparatus,
      the processing unit computes a time until a change of a reference value or more occurs in the region, and sets the computed time to the sampling interval for the each region, by processing an image in a past.
17. The surveillance image generation system according to any one of supplementary notes 10 to 16, wherein
   a sampling interval of a plurality of the images differs depending on a photographing target.
18. The surveillance image generation system according to any one of supplementary notes 10 to 17, wherein,
   in the image processing apparatus,
      the selection unit determines that the difference is equal to or less than a criterion, when a change in hue of the image is equal to or less than a criterion and a change in brightness is equal to or more than a criterion.
19. An image processing method including,
   by an image processing apparatus:
   acquiring a plurality of images acquired by photographing a same location at different timing;
   comparing at least two of the plurality of images, and selecting a target region being a region where a difference between the two images satisfies a criterion; and
   performing average processing of averaging the target region included in each of the at least two images.
20. The image processing method according to supplementary note 19, further including,
   by the image processing apparatus,
   until the average processing is performed for a region of a reference range or more within the image:
      comparing the at least two images by changing a combination of the images to be compared; and
      repeating the average processing.
21. The image processing method according to supplementary note 19 or 20, wherein
   a unit of the region is one pixel.
22. The image processing method according to any one of supplementary notes 19 to 21, further including,
   by the image processing apparatus
      applying a weight to the image by using a difference from the latest image on a time axis, when performing the average processing.
23. The image processing method according to supplementary note 22, further including,
   by the image processing apparatus,
      repeatedly selecting two images adjacent to each other in a time-series manner; and
      performing the average processing each time the two images are selected, wherein
   a result of the average processing including, for the each target region, information indicating a first term indicating a value acquired by multiplying a value of the target region by a weighting factor, and a second term indicating the weighting factor used in the multiplication, and is stored in a storage unit,
   the image processing method further including, by the image processing apparatus,
      when performing the average processing for the subsequent two images, adding, to the result of the average processing stored in the storage unit, the first term and the second term of the target region of the image at this time.
24. The image processing method according to any one of supplementary notes 19 to 23, further including
   by the image processing apparatus,
      performing the average processing by setting a sampling interval of the image according to the region.
25. The image processing method according to supplementary note 24, further including,
   by the image processing apparatus,
      computing a time until a change of a reference value or more occurs in the region, and setting the computed time to the sampling interval for the each region, by processing an image in a past.
26. The image processing method according to any one of supplementary notes 19 to 25, wherein
   a sampling interval of a plurality of the images differs depending on a photographing target.
27. The image processing method according to any one of supplementary notes 19 to 26, further including,
   by the image processing apparatus,
      determining that the difference is equal to or less than a criterion, when a change in hue of the image is equal to or less than a criterion and a change in brightness is equal to or more than a criterion.
28. A program causing a computer to execute:
   a procedure of acquiring a plurality of images acquired by photographing a same location at different timing;
   a procedure of comparing at least two of the plurality of images, and selecting a target region being a region where a difference between the two images satisfies a criterion; and
   a procedure of performing average processing of averaging the target region included in each of the at least two images.
29. The program according to supplementary note 28, causing the computer to further execute,
   until the average processing is performed for a region of a reference range or more within the image:
      a procedure of comparing the at least two images by changing a combination of the images to be compared: and
      a procedure of repeating the average processing.
30. The program according to supplementary note 28 or 29, wherein
   a unit of the region is one pixel.
31. The program according to any one of supplementary notes 28 to 30, causing the computer to further execute
   a procedure of applying a weight to the image by using a difference from the latest image on a time axis, when performing the average processing.
32. The program apparatus according to supplementary note 31, causing the computer to further execute:
   a procedure of repeatedly selecting two images adjacent to each other in a time-series manner; and
   a procedure of performing the average processing each time the two images are selected, wherein
   a result of the average processing includes, for the each target region, information indicating a first term indicating a value acquired by multiplying a value of the target region by a weighting factor, and a second term indicating the weighting factor used in the multiplication, and is stored in a storage unit,
   the program causing the computer to further execute
   a procedure of, when performing the average processing for the subsequent two images, adding, to the result of the average processing stored in the storage unit, the first term and the second term of the target region of the image at this time.
33. The program according to any one of supplementary notes 28 to 32, causing the computer to further execute
   a procedure of performing the average processing by setting a sampling interval of the image according to the region.
34. The program according to supplementary note 33, causing the computer to further execute
   a procedure of computing a time until a change of a reference value or more occurs in the region, and setting the computed time to the sampling interval for the each region, by processing an image in a past.
35. The program according to any one of supplementary notes 28 to 34, wherein
   a sampling interval of a plurality of the images differs depending on a photographing target.
36. The program according to any one of supplementary notes 28 to 35, causing the computer to further execute
   a procedure of determining that the difference is equal to or less than a criterion, when a change in hue of the image is equal to or less than a criterion and a change in brightness is equal to or more than a criterion.

### REFERENCE SIGNS LIST

1 Surveillance image generation system
3 Communication network
5 Camera
10 POS cash register
20 Display shelf
100 Image processing apparatus
102 Acquisition unit
104 Selection unit
106 Processing unit
110 Storage apparatus
120 Result information
1000 Computer
1010 Bus
1020 Processor
1030 Memory
1040 Storage device
1050 Input/output interface
1060 Network interface

What is claimed is:

1. An image processing apparatus comprising:
at least one memory configured to store instructions; and
at least one processor configured to execute the instructions to:
acquire a plurality of images acquired by photographing a same location at different timing;
compare at least two of the plurality of images, and select a target region being a region where a difference between the two images is equal to or less than a criterion; and
perform average processing of averaging the target region included in each of the at least two images.

2. The image processing apparatus according to claim 1, wherein
the at least one processor is further configured to execute the instructions to,
until the average processing is performed for a region of a reference range or more within the image,
compare the at least two images by changing a combination of the images to be compared, and
repeat the average processing.

3. The image processing apparatus according to claim 1, wherein
a unit of the region is one pixel.

4. The image processing apparatus according to claim 1, wherein
the at least one processor is further configured to execute the instructions to
apply a weight to the image by using a difference from the latest image on a time axis, when performing the average processing.

5. The image processing apparatus according to claim 4, wherein
the at least one processor is further configured to execute the instructions to:
repeatedly select two images adjacent to each other in a time-series manner,
perform the average processing each time selecting the two images,
a result of the average processing includes, for the each target region, information indicating a first term indicating a value acquired by multiplying a value of the target region by a weighting factor, and a second term indicating the weighting factor used in the multiplication, and is stored in a storage unit, and,
wherein the at least one processor is further configured to execute the instructions to
when performing the average processing for the subsequent two images, add, to the result of the average processing stored in the storage unit, the first term and the second term of the target region of the image at this time.

6. The image processing apparatus according to claim 1, wherein
the at least one processor is further configured to execute the instructions to
perform the average processing by setting a sampling interval of the image according to the region.

7. The image processing apparatus according to claim 6, wherein
the at least one processor is further configured to execute the instructions to
compute a time until a change of a reference value or more occurs in the region, and set the computed time to the sampling interval for the each region, by processing an image in a past.

8. The image processing apparatus according to claim 1, wherein
a sampling interval of a plurality of the images differs depending on a photographing target.

9. The image processing apparatus according to claim 1, wherein
the at least one processor is further configured to execute the instructions to
determine that the difference is equal to or less than a criterion, when a change in hue of the image is equal to or less than a criterion and a change in brightness is equal to or more than a criterion.

10. (canceled)

11. An image processing method comprising,
by an image processing apparatus:
acquiring a plurality of images acquired by photographing a same location at different timing;
comparing at least two of the plurality of images, and selecting a target region being a region where a difference between the two images is equal to or less than a criterion; and
performing average processing of averaging the target region included in each of the at least two images.

12. A non-transitory computer-readable storage medium storing a program causing a computer to execute:
a procedure of acquiring a plurality of images acquired by photographing a same location at different timing;
a procedure of comparing at least two of the plurality of images, and selecting a target region being a region where a difference between the two images is equal to or less than a criterion; and
a procedure of performing average processing of averaging the target region included in each of the at least two images.
